(19) United States
(12) Patent Application Publication
(10) Pub. No.: US 2026/0335806 A1
(43) Pub. Date: Oct. 29, 2026

(54) CONDENSER SYSTEM FOR SYNTHESIS GASES

(71) Applicant: AIREX ENERGIE INC., Laval (CA)

(72) Inventor: Guy PRUD'HOMME, Laval (CA)

(21) Appl. No.: 19/655,863

(22) Filed: Apr. 23, 2026

Related U.S. Application Data
(60) Provisional application No. 63/793,891, filed on Apr. 24, 2025.

(51) Int. Cl. B01D 53/00; B01D 53/18

(52) U.S. Cl. CPC B01D 53/002; B01D 53/18; B01D 2252/205; B01D 2257/108; B01D 2257/502; B01D 2258/02

(57) ABSTRACT

A system for capturing synthesis gases from a process, the system may have an oil circuit including a gas capture stage in which a flow of synthesis gases is mixed with an oil stream for at least a portion of the synthesis gases from the flow to be condensed into the oil stream, a cooling stage in which the oil stream is cooled, and a motive force source to cycle the oil stream between the gas capture stage and the cooling stage. A cooling circuit may include a heat-exchange stage in which a coolant or refrigerant absorbs heat from the oil stream in the cooling stage of the oil circuit, and a heat-release stage in which the coolant or refrigerant releases heat, the coolant or refrigerant cycling between the heat-exchange stage and the heat-release stage.

### CROSS-REFERENCE TO RELATED APPLICATION

The present application claims the benefit of United States Patent Application No. 63/793,891, filed on Apr. 24, 2025, the entire contents of which are incorporated herein by reference.

### TECHNICAL FIELD

The present disclosure relates to the capture of synthesis gases that may be produced in various processes, and more particularly to a method and apparatus therefor.

### BACKGROUND

Recuperation of unwanted biomass in various fields is an increasingly valued proposition in a green economy. Some solutions for recuperation of unwanted biomass have been to process the biomass to form combustible pellets, granules, powder. To do so, methods and apparatuses have been developed in which the biomass is thermally treated to reduce the moisture content therein, with a goal to be as efficient as possible. The generation of combustible products from biomass requires energy, and thus must be reconciled with a plurality of parameters to ensure that the process maintains a positive impact. The plurality of parameters may include energy cost, energy source, transportation costs, energy consumption, and containment of pollutants and by-products.

One such by-product is synthesis gas, also known as syngas. Syngas may include various gases, such as hydrogen (H₂), carbon monoxide (CO), methane (CH₄), carbon dioxide (CO₂), and other gases. Syngas may result from gasification occurring during thermal treatment of biomass, in which the carbon-rich biomass is subjected to thermal treatment in the presence of oxygen. Among these gases, some are hazardous to human health and to the environment if released in an uncontrolled manner. For example, carbon monoxide is toxic, and carbon dioxide is a greenhouse gas. Thus, the uncontrolled release of syngas from biomass processing operations may pose safety, health, and environmental concerns. It would therefore be desirable to capture syngases in an efficient and reliable manner that reduces environmental emissions.

### SUMMARY

In accordance with a first aspect of the present disclosure, there is provided a system for capturing synthesis gases from a process, the system comprising: an oil circuit including a gas capture stage in which a flow of synthesis gases is mixed with oil for at least a portion of the synthesis gases from the flow to be condensed into the oil, a cooling stage in which the oil is cooled, and a motive force source to cycle the oil between the gas capture stage and the cooling stage; a cooling circuit including a heat-exchange stage in which a coolant or refrigerant absorbs heat from the oil stream in the cooling stage of the oil circuit, and a heat-release stage in which the coolant or refrigerant releases heat, the coolant or refrigerant cycling between the heat-exchange stage and the heat-release stage.

Further in accordance with the first aspect, for instance, the oil circuit includes at least one accumulator for storing the oil.

Still further in accordance with the first aspect, for instance, the at least one accumulator is a displaceable tote configured to releasably connected to the oil circuit.

Still further in accordance with the first aspect, for instance, the motive force source is a pump.

Still further in accordance with the first aspect, for instance, the gas capture stage includes a reservoir in fluid communication with a conduit through which the synthesis gases are directed, and one or more oil injectors configured to generate an oil stream for mixing with the synthesis gases.

Still further in accordance with the first aspect, for instance, the reservoir is in the form of a hopper having a tapering bottom, an inlet at a top thereof in fluid communication with the conduit, and an outlet at a bottom thereof.

Still further in accordance with the first aspect, for instance, the cooling stage is located below the reservoir such that oil with condensed synthesis gases flows from the reservoir to the cooling stage at least partly by gravity.

Still further in accordance with the first aspect, for instance, at least one shell and tube heat exchanger includes the cooling stage of the oil circuit and the heat-exchange stage of the cooling circuit.

Still further in accordance with the first aspect, for instance, the system includes at least two shell and tube heat exchangers, the shell and tube heat exchangers being arranged in a serial arrangement.

Still further in accordance with the first aspect, for instance, the coolant or refrigerant circulates in tubes of the at least one shell and tube heat exchanger and the oil circulates in a shell of the at least one shell and tube heat exchanger.

Still further in accordance with the first aspect, for instance, the cooling circuit includes at least one accumulator for storing the coolant or refrigerant.

Still further in accordance with the first aspect, for instance, the at least one accumulator of the cooling circuit includes a first accumulator on a hot side of the cooling circuit and a second accumulator on a cold side of the cooling circuit, and a bypass-line interrelating the first accumulator and the second accumulator.

Still further in accordance with the first aspect, for instance, the heat-release stage includes at least one condenser unit.

Still further in accordance with the first aspect, for instance, the at least one condenser unit is an air-cooled condenser unit having coils and at least one fan configured to blow air against the coils.

Still further in accordance with the first aspect, for instance, the cooling circuit includes a pipe network having a hot pipe directing coolant or refrigerant from the heat-exchange stage to the heat-release stage, and a cold pipe directing coolant or refrigerant from the heat-release stage to the heat-exchange stage.

Still further in accordance with the first aspect, for instance, the gas capture stage includes a conduit in which the synthesis gases circulate, and a second conduit merging with the conduit in a cross-shape arrangement such that a portion of the flow of synthesis gases is diverted from the conduit into the second conduit.

Still further in accordance with the first aspect, for instance, the coolant or refrigerant circulates in a direction opposite to a direction of the oil through the cooling stage, forming a countercurrent flow arrangement.

Still further in accordance with the first aspect, for instance, a controller is in the system and has one or more processor units and non-transitory computer-readable memory storing instructions executable by the one or more processor units to operate the oil circuit and the cooling circuit.

Still further in accordance with the first aspect, for instance, the non-transitory computer-readable memory storing instructions executable by the one or more processor units for causing the system to: mix a flow of synthesis gases with an oil stream for at least a portion of the synthesis gases from the flow to be condensed into the oil stream, cooling the oil stream having synthesis gases condensed therein, and cycling the oil stream in the oil circuit between the mixing and the cooling; and concurrently, in a cooling circuit: absorbing heat from the oil stream with a coolant or refrigerant in heat exchange with the oil stream in the cooling stage of the oil circuit, releasing heat from the coolant or refrigerant, and cycling the coolant or refrigerant between the absorbing and the releasing.

In accordance with a second aspect of the present disclosure, there is provided a method for capturing synthesis gases comprising: in an oil circuit: mixing a flow of synthesis gases with an oil stream for at least a portion of the synthesis gases from the flow to be condensed into the oil stream, cooling the oil stream having synthesis gases condensed therein, and cycling the oil stream in the oil circuit between the mixing and the cooling; and concurrently, in a cooling circuit: absorbing heat from the oil stream with a coolant or refrigerant in heat exchange with the oil stream in the cooling stage of the oil circuit, releasing heat from the coolant or refrigerant, and cycling the coolant or refrigerant between the absorbing and the releasing.

### BRIEF DESCRIPTION OF THE DRAWINGS

Further features and advantages of the present disclosure will become apparent from the following detailed description, taken in combination with the appended drawings, in which:

FIG. 1 is a condenser system for condensing synthesis gases in accordance with a variant of the present disclosure;

FIG. 2 is a perspective view of an exemplary set up of the condenser system of FIG. 1;

FIG. 3 is a first elevation view of the exemplary set up of the condenser system of FIG. 2;

FIG. 4 is a second elevation view of the exemplary set up of the condenser system of FIG. 2;

FIG. 5 is a perspective view of a heat exchanger between an oil circuit and a cooling circuit of the condenser system of FIG. 2;

FIG. 6 s a perspective view of an exemplary set up of the cooling circuit of the condenser system of FIG. 2; and

FIG. 7 is a perspective view of an exemplary set up of receivers in the cooling circuit of the condenser system of FIG. 6.

Many further features and combinations thereof concerning the present improvements to those skilled in the art following a reading of the instant disclosure.

### DETAILED DESCRIPTION

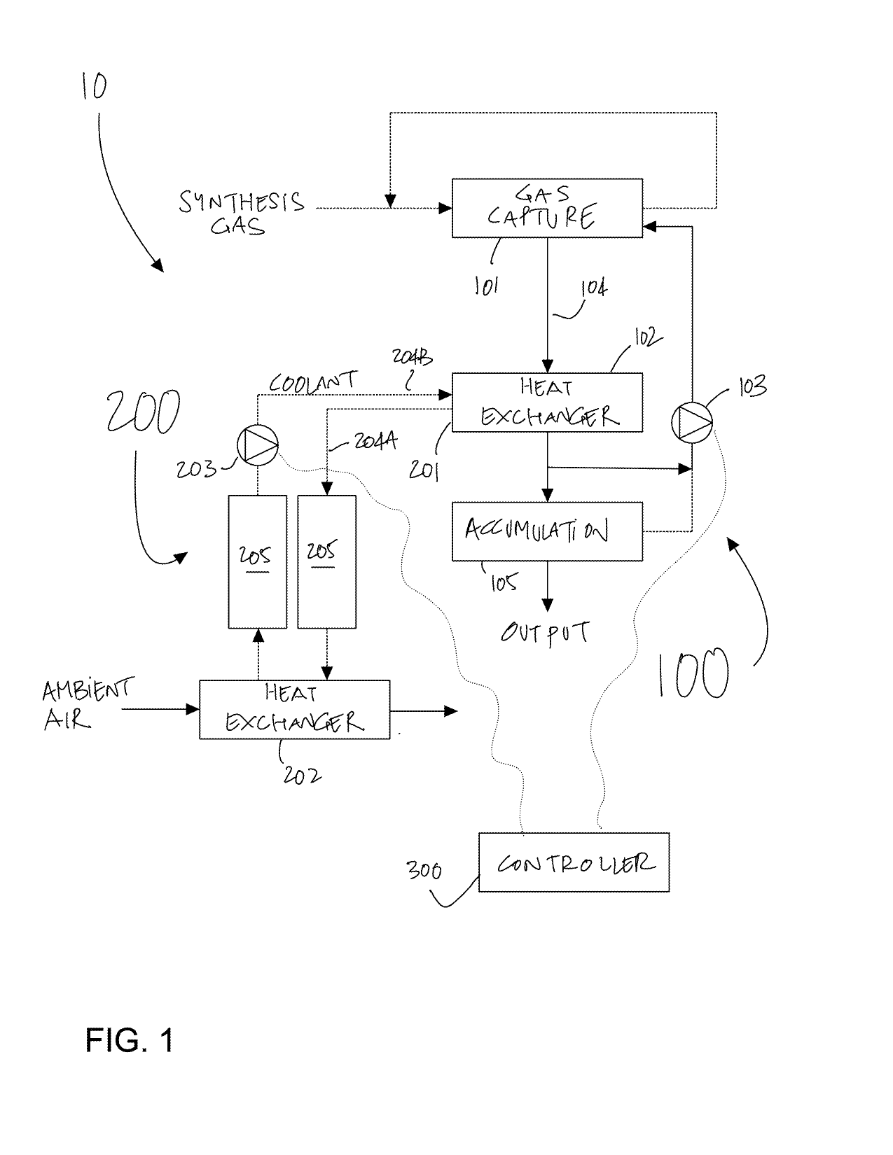

Referring to the drawings and more particularly to FIG. 1, there is shown a system 10 for capturing synthesis gases (a.k.a., syngas, syngases) from a process. The system 10 may be referred to as a condenser system 10 as it may condense syngases into a condensate, i.e., into liquid form. The process may be any one of a number of processes that may involve the generation of synthesis gases, such as a process that involves drying, torrefying and/or increasing energy density of biomass. Just by way of example, the syngases may be produced by an apparatus for drying biomass as described in International Patent Application No. PCT/CA2024/050760, by an apparatus for torrefying biomass as described in US Patent No. 9,683,187 and US Patent No. 10,450,523, the contents of all of which are incorporated herein by reference. The present system 10 is not limited to use with biomass processing, however, and may be used in connection with any process that produces synthesis gases, including but not limited to waste gasification, pyrolysis, coal gasification, and other thermochemical conversion processes.

The system 10 may have an oil circuit 100 and a cooling circuit 200. A controller 300 may be present to control the various components of the system 10, the controller 300 having one or more processor units and non-transitory instructions executable by the one or more processor units to operate the system 10 in the manner described herein, notably to actuate motors, pumps, or like motive force sources, to monitor temperatures and/or pressures, to open and/or close valves, etc. The controller 300 may further coordinate the operation of the oil circuit 100 and the cooling circuit 200 so as to maintain suitable conditions for syngas condensation and capture. The controller 300 may receive signals from one or more sensors (e.g., temperature sensors, pressure sensors, flow sensors) disposed at various locations in the oil circuit 100 and/or the cooling circuit 200, and may use such signals to regulate the operation of the system 10.

The oil circuit 100 is the part of the system 10 in which syngas is mixed with oil, for the syngas to condense and be captured by the oil. Although oil is the capture fluid in the variants described herein, other types of capture fluids may be used as well including without limitation other hydrocarbon-based fluids, silicone-based fluids, or other fluids that are suitable for absorbing and condensing syngas components. For simplicity, reference is made herein to the oil circuit 100 even though other capture fluids could be used. The cooling circuit 200 is provided to remove heat from the oil circuit 100, to maintain the oil or like fluid in suitable conditions to capture and condense the syngas.

The oil circuit 100 may have a gas capture stage 101 in which a flow of synthesis gases is mixed with an oil stream (including an oil mist). As a result, a portion of the synthesis gases from the flow may be condensed into the oil stream. The oil circuit 100 may further have a cooling stage 102 in which the oil stream is cooled. A motive force source 103 may be operated to cycle the oil stream between the gas capture stage 101 and the cooling stage 102. A pipe network 104 with appropriate components, such as valves, ports, and sensors provides fluid communication between the various stages and components of the oil circuit 100, i.e., the gas capture stage 101, the cooling stage 102, and the motive force source 103. The pipe network 104 may include any suitable conduits, fittings, manifolds, and instrumentation for conveying the oil stream between the stages and components of the oil circuit 100.

One or more accumulators 105 may be present for storing the oil, and may serve as an output for oil. For example, the accumulators 105 are shown as being totes that may be displaced and replaced. By using displaceable totes, the oil containing condensed syngas may be removed from the system 10 for downstream processing, and fresh oil may be provided to the oil circuit 100 via replacement totes. In a variant, the oil circuit 100 may cycle at least some of the oil, such that at least a portion of the oil travels between the gas capture stage 101 and the cooling stage 102. In another variant, the accumulators 105 selectively lead out of the network of pipes 104, to remove some of the syngas condensate in the oil. Replacement oil may then be added to the oil circuit 100.

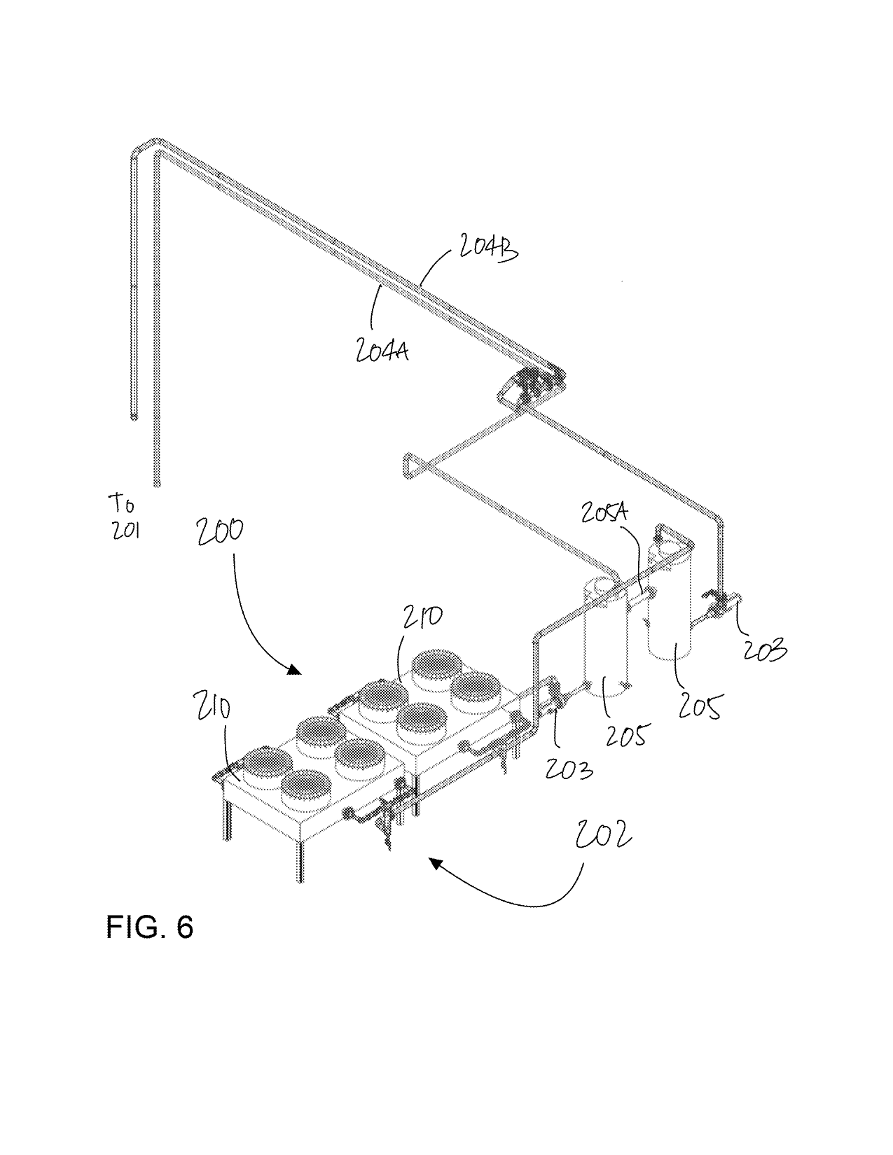

The cooling circuit 200 may include a heat-exchange stage 201 and a heat-release stage 202, in which a coolant circulates. Although the expression “coolant” is used, the fluid in the cooling circuit 200 may also be referred to as a refrigerant. For simplicity, the expression “coolant” is used herein, though the fluid may be a refrigerant. The coolant may or may not change phase in the cooling circuit 200, and may for example be an alcohol-based fluid such as glycol (e.g., ethylene glycol, propylene glycol), a liquid such as water or brine, a synthetic refrigerant (e.g., a hydrofluorocarbon or hydrofluoroolefin), etc. The heat-exchange stage 201 is the part of the cooling circuit 200 in which the coolant absorbs heat from the oil stream in the cooling stage 102 of the oil circuit 100. In the heat-release stage 202, the coolant releases heat, such as to the atmosphere, to another heat sink, to a heat reclaim source, etc. A motive force source 203 may be operated to cycle the coolant between the heat-exchange stage 201 and the heat-release stage 202. A pipe network 204 with appropriate components, such as valves, ports, sensors provides a fluid communication between the various stages and components of the cooling circuit 200, i.e., the heat-exchange stage 201 and the heat-release stage 202, and the motive force source 203, shown in FIG. 6 as being a pump, among other possibilities (e.g., thermosiphon, compressor, etc). One or more accumulators 205 may be present for storing the coolant.

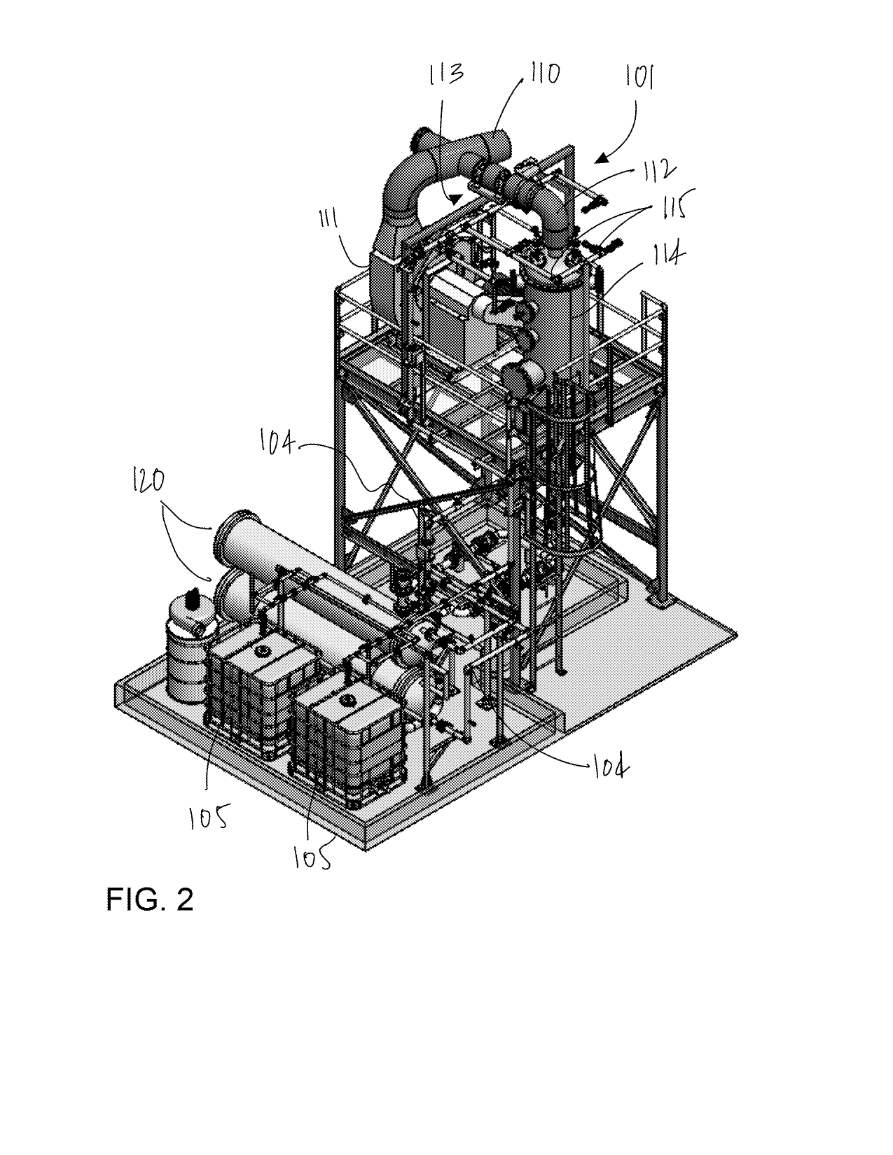

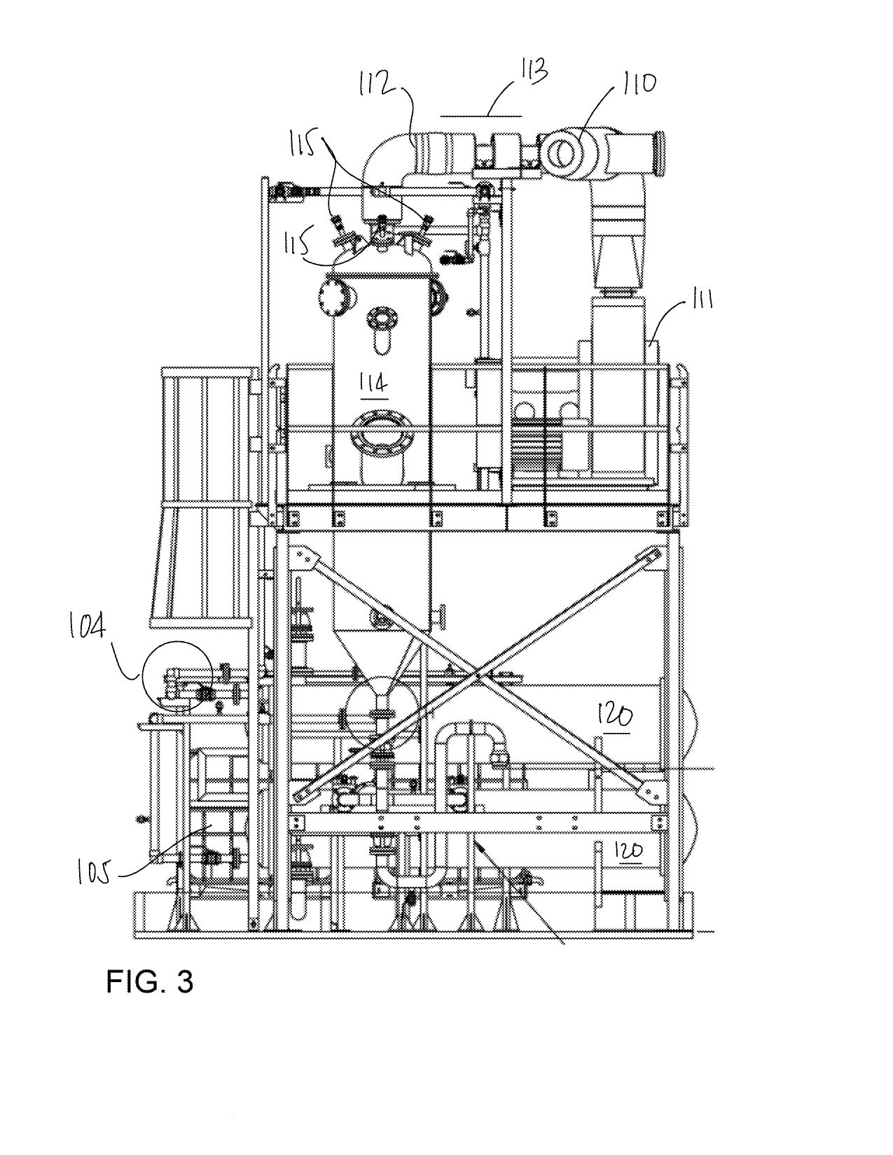

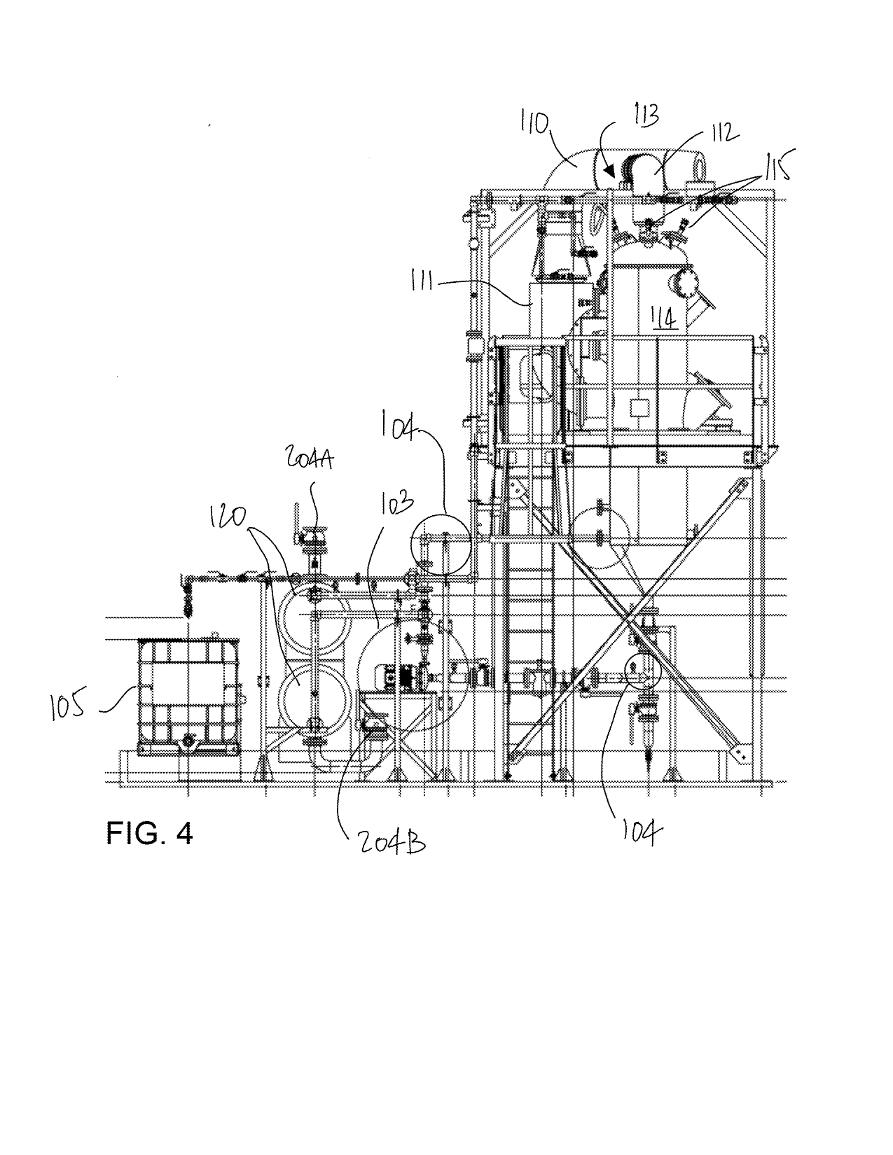

Now that the general components of the system 10 have been described with respect to FIG. 1, an implementation thereof is set out, with reference to FIGS. 2 to 7. The implementation described below is only one of numerous possible configurations of the system 10, and that various modifications and alternatives are within the scope of the present disclosure.

Referring to FIGS. 2-4, the gas capture stage 101 is shown as including a merger between a conduit 110 in which syngas circulates as driven by a ventilator 111 (or blower, fan, etc), and a conduit 112. The conduit 110 may be part of a circuit in which syngas is removed from a process, and in which the syngas cycles, as a possibility among others. The conduits 110 and 112 merge in a cross-shape arrangement as one possible configuration among others, such that only a portion of the flow of syngas is diverted from the conduit 110 to be directed into the oil circuit 100 via the conduit 112. By diverting a selected portion of the syngas flow, the system 10 may regulate the amount of syngas entering the gas capture stage 101 and may avoid overwhelming the capacity of the oil to absorb the syngas. Other configurations for the merger of the conduits 110 and 112 are possible, including T-shaped junctions, Y-shaped junctions, or other arrangements that direct syngas into the conduit 112.

In the conduit 112, valves are present in the segment shown at 113, to open, close and/or control the flow of syngas into the system 10. The valves in segment 113 may be operated by the controller 300 to regulate the flow rate and/or pressure of syngas entering the gas capture stage 101, thereby ensuring that conditions are suitable for condensation and capture.

The conduit 112 may then lead the syngas into a reservoir 114. The reservoir 114 may be in the form of a hopper (i.e., with a conical shaped bottom), as one possibility among others (e.g., a cylindrical reservoir 114 may be one of numerous alternatives). The hopper configuration may be advantageous as the conical bottom (or like tapering bottom) facilitates the collection and drainage of condensed oil and syngas condensate by gravity toward an outlet at the bottom of the reservoir 114. Thus, the reservoir 114 may be connected to the conduit 112 at a top thereof, with an output or outlet of the reservoir 114 being at a bottom thereof. Hence, gas that may accumulate in the reservoir 114 may be exhausted from a top of the reservoir 114, through appropriate components (e.g., valves, pressure-release valve, conduits or pipe, etc). This arrangement facilitates separation of the condensed liquid (which flows downward by gravity) from any remaining uncondensed gases (which rise to the top of the reservoir 114).

Oil may be injected by any appropriate device such as jet(s), nozzle(s), nebulizer, etc, shown at 115 at various locations in the reservoir 114. The oil, or other capture fluid, is at a suitable temperature, to cause a condensation of the syngas from the stream, such that the syngas becomes a condensate mixed into oil. In a variant, the oil can be injected at multiple locations within the reservoir 114 may promote thorough mixing and intimate contact between the oil and the syngas, thereby improving the efficiency of syngas capture. This step may be continuous, in that the flow of syngas is controlled for the conditions in the segment 113 to be suitable for condensation and capture of the syngas into the oil or like fluid, in the reservoir 114 or elsewhere.

As observed from FIGS. 2-4, the reservoir 114 may be mounted atop a scaffold or like structure. Accordingly, the gas capture stage 101 may rely at least partly on gravity as motive force source for circulation of the oil therein. That is, oil with condensed syngas may flow downward from the reservoir 114 toward the cooling stage 102 under the influence of gravity, thereby reducing or eliminating the need for pumping in at least a portion of the oil circuit 100. Other configurations are possible as well, though the use of the permanent scaffold, allows a more compact arrangement of the oil circuit 100 relative to the cooling circuit 200 and/or a limited or reduced footprint.

A single set of conduit 112, segment 113, reservoir 114 with oil injectors 115 is shown, however, any one or more of these components may be in more than one unit in the arrangement shown. For instance, multiple reservoirs 114 may be provided in parallel to increase the capacity of the gas capture stage 101, or multiple conduits 112 with respective valve segments 113 may be used to divert syngas from multiple locations in the process.

Referring to FIGS. 2 to 5, the cooling stage 102 is embodied by a pair of shell and tube exchangers 120, in fluid communication with the reservoir 114 by the pipes of the pipe network 104. It can be observed that, in the illustrated embodiment, the cooling stage 102 is located below the reservoir 114, such that the cooling stage 102 may receive the oil with syngas condensate by gravity. However, other arrangements are possible, including using pump(s). On the other hand, the cooling stage 102 may direct oil that has been cooled using pump(s) 103 in the pipe network 104, as another type of motive force source. A thermosyphon is yet another possibility.

A pair of shell and tube exchangers 120 are shown in a stacked arrangement, i.e., one on top of the other, for allowing heat exchange between the oil of the oil circuit 100 and the coolant of the cooling circuit 200. Accordingly, the cooling stage 102 may have a serial arrangement of exchangers, such as by a first substage, i.e., the upper exchanger 120, and a second substage, i.e., the lower exchanger 120, with the temperature being lower in the lower exchanger 120. The serial arrangement may provide progressive cooling of the oil, with a first heat-exchange pass in the upper exchanger 120 and a second, deeper cooling pass in the lower exchanger 120. Again, gravity may contribute to the flow of coolant in the exchangers 120.

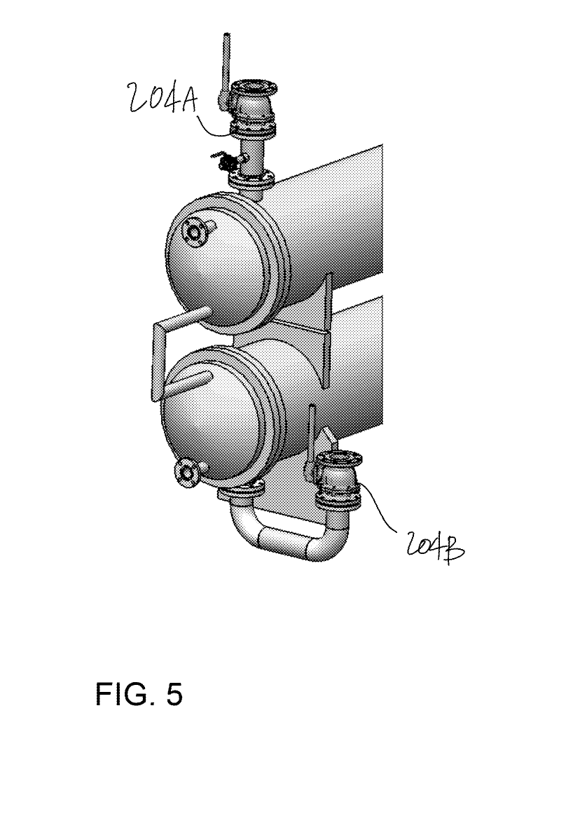

Moreover, while a pair of shell and tube exchangers 120 is shown, a single exchanger 120 could be present, or more than two exchangers 120 could be present. The serial arrangement of FIG. 5 is one possibility as parallel exchangers 120 could be used, or a combination of serial and parallel exchangers (e.g., 2x2). Moreover, shell and tube exchangers 120 are only one type of exchanger that could be used, the system 10 not being limited to shell and tube exchangers in the cooling stage 102. For example, radiators, plate exchangers, etc, are other types of exchangers that could be present.

In a variant, the coolant circulates in the tubes of the shell and tube exchangers 120, while the oil is in the shell. The reverse arrangement is also possible, i.e., with the oil circulating in the tubes and the coolant in the shell.

A portion of the oil may be accumulated in the one or more accumulators 105 (two shown), that are optionally present in the system 10. The accumulators 105 may also be referred to as receivers, tanks, reservoirs, totes, and ensure that a suitable amount of oil is in the oil circuit 100. The accumulators 105 may be in fluid communication with a remainder of the oil circuit 100 by the network of pipes 104. It can be observed that a disruption or disconnectable coupling may be present in the pipes 104 leading to the accumulators 105, to facilitate connection, and disconnection, such as when a replacement accumulator 105 is required. This feature allows spent oil containing condensed syngas to be readily removed from the system 10 and replaced with fresh oil, without requiring shutdown of the entire system 10

Pump 103 or like motive force source may be downstream of the cooling stage 102 to pump oil back to the oil injectors 114 for mixing with the syngas of the reservoir 114.

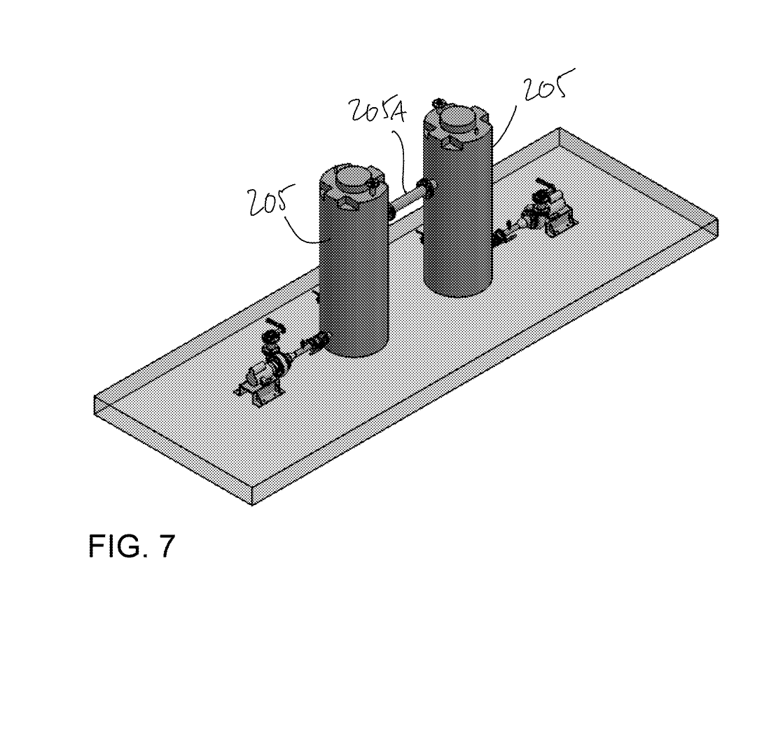

Referring to FIGS. 6 and 7, the cooling circuit 200 is shown having its pipe network 204 that is segmented into a hot pipe 204A and a cold pipe 204B. The hot pipe 204A directs coolant having absorbed heat from the oil in the cooling stage 102 of the oil circuit 100 (i.e., the heat-exchange stage 201) to the heat-release stage 202, while the cold pipe 204B directs coolant from the heat-release stage 202 to the heat-exchange stage 201. For example, the coolant circulates in a direction opposite to that of the oil in the shell and tube exchanger(s) 120, i.e., in a countercurrent flow arrangement, with the hot pipe 204A exiting from the upper exchanger 120, such as in proximity to the inlet of oil in the cooling stage 102. The countercurrent arrangement may improve the efficiency of heat transfer between the oil and the coolant. The reverse arrangement (i.e., co-current flow) is also possible.

Depending on the environment and available heat sink, the cooling circuit 200 may have different configurations for the heat-release stage 202. In a variant, as shown in FIG. 6, the heat-release stage 202 includes condenser units 210 (e.g., roof-top condenser units 210). The condenser units 210 are of the type having coils in which the coolant circulates, with a fluid blown against the coils for the fluid to capture heat from the coolant. For example, fans are present in the condenser units 210, and the fluid is air (e.g., outdoor air). While the expression “condenser unit” is used, condensation may or may not occur on the condenser units 210, depending on the state of the coolant. As alternatives to an air-cooled condenser or heat exchanger, water-cooled condensers, evaporative condensers could be used, as examples among others. The heat-release stage 202 may rely on an available water sink, or may reclaim heat from the coolant, to use the heat in the process or in another process. For example, the recovered heat may be used to pre-heat biomass, to heat a building, or for another thermal purpose, thereby improving overall energy efficiency of the process.

A portion of the coolant may be accumulated in the one or more accumulators 205 (two shown), that are optionally present in the system 10, with one accumulator 205 on the hot side of the coolant circuit 200, and another accumulator 205 on the cold side of the coolant circuit 200. A bypass-line 205A may interrelate the accumulators 205 to balance the level of coolant, or to enable multiple passes of coolant in the heat-release stage 202. The accumulators 205 may also be referred to as receivers, tanks, reservoirs, and ensure that a suitable amount of coolant is in the coolant circuit 200.

The controller 300 may be used to operate a process or like method with the system 10 or like system in the following manner: in an oil circuit: mixing a flow of synthesis gases with an oil stream for at least a portion of the synthesis gases from the flow to be condensed into the oil stream, cooling the oil stream having synthesis gases condensed therein, and cycling the oil stream in the oil circuit between the mixing and the cooling; and concurrently, in a cooling circuit: absorbing heat from the oil stream with a coolant or refrigerant in heat exchange with the oil stream in the cooling stage of the oil circuit, releasing heat from the coolant or refrigerant, and cycling the coolant or refrigerant between the absorbing and the releasing. The controller 300 may further regulate the flow of syngas into the gas capture stage 101 by controlling the valves in segment 113, and may regulate the flow rates of oil and coolant via control of the motive force sources 103, 203.

It will be appreciated that the system 10 and method described herein may be scaled up or down depending on the volume of syngas to be captured, the available space, and other operational requirements. Multiple systems 10 may be deployed in parallel for increased throughput, or a single system 10 may be sized to handle the syngas output from a particular process.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

1. A system for capturing synthesis gases from a process, the system comprising:
an oil circuit including
a gas capture stage in which a flow of synthesis gases is mixed with oil for at least a portion of the synthesis gases from the flow to be condensed into the oil,
a cooling stage in which the oil is cooled, and
a motive force source to cycle the oil between the gas capture stage and the cooling stage;
a cooling circuit including
a heat-exchange stage in which a coolant or refrigerant absorbs heat from the oil stream in the cooling stage of the oil circuit, and
a heat-release stage in which the coolant or refrigerant releases heat, the coolant or refrigerant cycling between the heat-exchange stage and the heat-release stage.

2. The system according to claim 1, wherein the oil circuit includes at least one accumulator for storing the oil.

3. The system according to claim 2, wherein the at least one accumulator is a displaceable tote configured to releasably connected to the oil circuit.

4. The system according to claim 1, wherein the motive force source is a pump.

5. The system according to claim 1, wherein the gas capture stage includes a reservoir in fluid communication with a conduit through which the synthesis gases are directed, and one or more oil injectors configured to generate an oil stream for mixing with the synthesis gases.

6. The system according to claim 5, wherein the reservoir is in the form of a hopper having a tapering bottom, an inlet at a top thereof in fluid communication with the conduit, and an outlet at a bottom thereof.

7. The system according to claim 5, wherein the cooling stage is located below the reservoir such that oil with condensed synthesis gases flows from the reservoir to the cooling stage at least partly by gravity.

8. The system according to claim 1, wherein at least one shell and tube heat exchanger includes the cooling stage of the oil circuit and the heat-exchange stage of the cooling circuit.

9. The system according to claim 8, wherein the system includes at least two shell and tube heat exchangers, the shell and tube heat exchangers being arranged in a serial arrangement.

10. The system according to claim 8, wherein the coolant or refrigerant circulates in tubes of the at least one shell and tube heat exchanger and the oil circulates in a shell of the at least one shell and tube heat exchanger.

11. The system according to claim 1, wherein the cooling circuit includes at least one accumulator for storing the coolant or refrigerant.

12. The system according to claim 11, wherein the at least one accumulator of the cooling circuit includes a first accumulator on a hot side of the cooling circuit and a second accumulator on a cold side of the cooling circuit, and a bypass-line interrelating the first accumulator and the second accumulator.

13. The system according to claim 1, wherein the heat-release stage includes at least one condenser unit.

14. The system according to claim 13, wherein the at least one condenser unit is an air-cooled condenser unit having coils and at least one fan configured to blow air against the coils.

15. The system according to claim 1, wherein the cooling circuit includes a pipe network having a hot pipe directing coolant or refrigerant from the heat-exchange stage to the heat-release stage, and a cold pipe directing coolant or refrigerant from the heat-release stage to the heat-exchange stage.

16. The system according to claim 1, wherein the gas capture stage includes a conduit in which the synthesis gases circulate, and a second conduit merging with the conduit in a cross-shape arrangement such that a portion of the flow of synthesis gases is diverted from the conduit into the second conduit.

17. The system according to claim 1, wherein the coolant or refrigerant circulates in a direction opposite to a direction of the oil through the cooling stage, forming a countercurrent flow arrangement.

18. The system according to claim 1, further including a controller having one or more processor units and non-transitory computer-readable memory storing instructions executable by the one or more processor units to operate the oil circuit and the cooling circuit.

19. The system according to claim 18, wherein the non-transitory computer-readable memory storing instructions executable by the one or more processor units for causing the system to:
mix a flow of synthesis gases with an oil stream for at least a portion of the synthesis gases from the flow to be condensed into the oil stream,
cooling the oil stream having synthesis gases condensed therein, and
cycling the oil stream in the oil circuit between the mixing and the cooling; and concurrently, in a cooling circuit:
absorbing heat from the oil stream with a coolant or refrigerant in heat exchange with the oil stream in the cooling stage of the oil circuit,
releasing heat from the coolant or refrigerant, and
cycling the coolant or refrigerant between the absorbing and the releasing.

20. A method for capturing synthesis gases comprising:
in an oil circuit:
mixing a flow of synthesis gases with an oil stream for at least a portion of the synthesis gases from the flow to be condensed into the oil stream,
cooling the oil stream having synthesis gases condensed therein, and
cycling the oil stream in the oil circuit between the mixing and the cooling; and concurrently,
in a cooling circuit:
absorbing heat from the oil stream with a coolant or refrigerant in heat exchange with the oil stream in the cooling stage of the oil circuit,
releasing heat from the coolant or refrigerant, and
cycling the coolant or refrigerant between the absorbing and the releasing.
